(19) United States
(12) Patent Application Publication
(10) Pub. No.: US 2025/0048203 A1
(43) Pub. Date: Feb. 6, 2025

(54) DETECTING AND REDUCING PING-PONG HANDOVER

(71) Applicant: QUALCOMM Incorporated, San Diego, CA (US)

(72) Inventors: Jiaheng LIU, Shanghai (CN); Mouaffac AMBRISS, San Diego, CA (US); Arvind Vardarajan SANTHANAM, San Diego, CA (US); Tom CHIN, San Diego, CA (US); Yuanbo WANG, San Diego, CA (US); Lianfeng LI, San Diego, CA (US)

(21) Appl. No.: 18/716,913

(22) PCT Filed: Feb. 25, 2022
(86) PCT No.: PCT/CN2022/077859

§ 371 Date: Jun. 5, 2024

(51) Int. Cl. H04W 36/00

(52) U.S. Cl. CPC H04W 36/00835; H04W 36/0094; H04W 36/0069

(57) ABSTRACT

The UE may store target cell information to a database based on performing a handover to the target cell and detecting the ping-pong handover based on a number of handover instances in the database of the target cell to which the UE has performed the handover being greater than or equal to a threshold number of the handover instances within a period of time. The UE may receive, from a base station a list of ping-pong cell candidates and configure the number of handover instances of the target cell and/or the period of time based on the list of ping-pong cell candidates. The UE may avoid or reduce the handover to the identified ping-pong cell based on the detected ping-pong handover by applying an offset to the measurement of the target cell.

### TECHNICAL FIELD

The present disclosure relates generally to communication systems, and more particularly, to a method of wireless communication for detecting and reducing ping-pong handover.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may include a user equipment (UE). The UE may store target cell information to a database based on performing a handover to the target cell and detecting a ping-pong handover based on a number of handover instances in the database of the target cell to which the UE has performed the handover being greater than or equal to a threshold number of the handover instances within a period of time. The UE may receive, from a base station a list of ping-pong cell candidates and configure the number of handover instances of the target cell and/or the period of time based on the list of ping-pong cell candidates. The UE may avoid or reduce the handover to the identified ping-pong cell based on the detected ping-pong handover by applying an offset to the measurement of the target cell.

In an aspect of the disclosure, a method, a computer-readable medium, and an apparatus are provided for communication at a network node. The network node determines a list of cells that are candidates for a handover condition and transmits the list of cells associated with at least one of a threshold number of instances of a target cell or a period of time for detecting the handover condition, where the handover condition is based on the threshold number of instances of the target cell in a database of target cells to which a UE has performed the handover within the period of time.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates a network of wireless communication including the ping-pong handover detection and management.

FIG. 5 is a method of wireless communication, in accordance with various aspects of the present disclosure.

FIG. 6 is a call-flow diagram of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

### DETAILED DESCRIPTION

When a UE is exposed to a neighboring cell with fluctuating measurements, the UE may trigger repeated handovers of the call in progress between the neighboring cell and the serving cell, which may be referred to as ping-pong handovers. The ping-pong handovers may cause increased dropped calls and/or increased quality degradation, transmission interruption, or a negative impact on UE throughput. The UE may be configured to maintain a database of target cell information and detect the ping-pong handover based the database. The UE may also avoid or reduce the handover to the target cell of the detected ping-pong handover by applying an offset to the measurement of the target cell.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

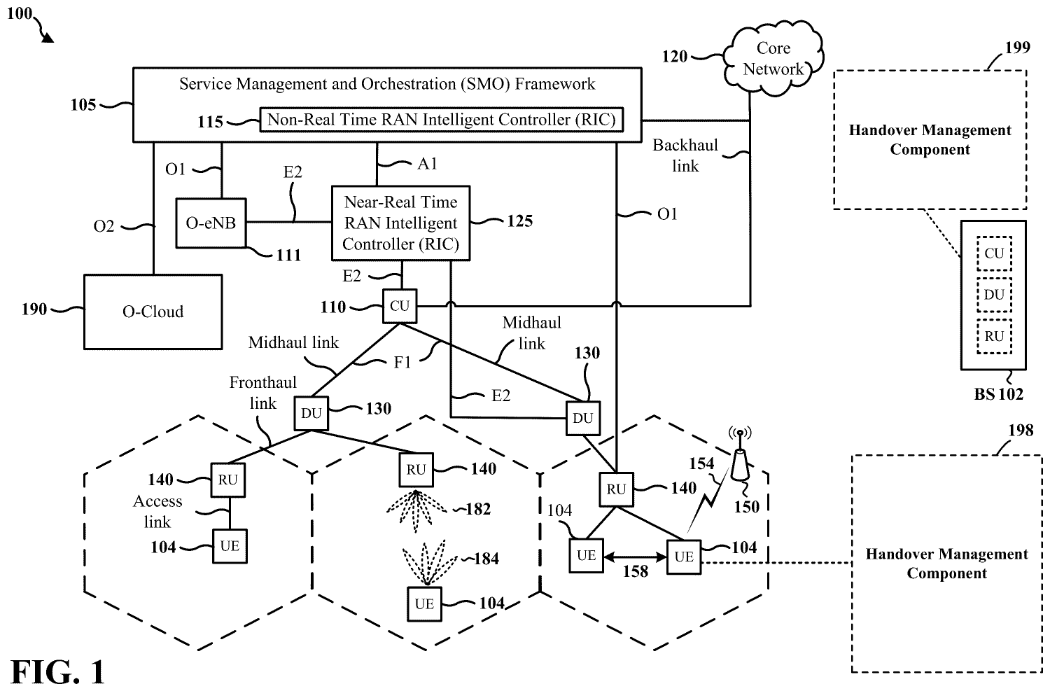

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a handover management component 198 configured to perform a handover to a target cell, store target cell information for the target cell in database of target cells to which the UE has performed the handover, and detect a handover condition based on a number of instances of the target cell in the database of the target cells to which the UE has performed the handover. In certain aspects, the base station 102 may include a handover management component 199 configured to determine a list of cells that are candidates for a handover condition, and transmit the list of cells associated with at least one of a threshold number of instances of a target cell or a period of time for detecting a handover condition, wherein the handover condition is detected based on the at least one of the number of instances of the target cell in a database of the target cells to which a UE has performed the handover for the period of time. Although the following description may be focused on 5G NR, the concepts described herein may be applicable to other similar areas, such as LTE, LTE-A, CDMA, GSM, and other wireless technologies.

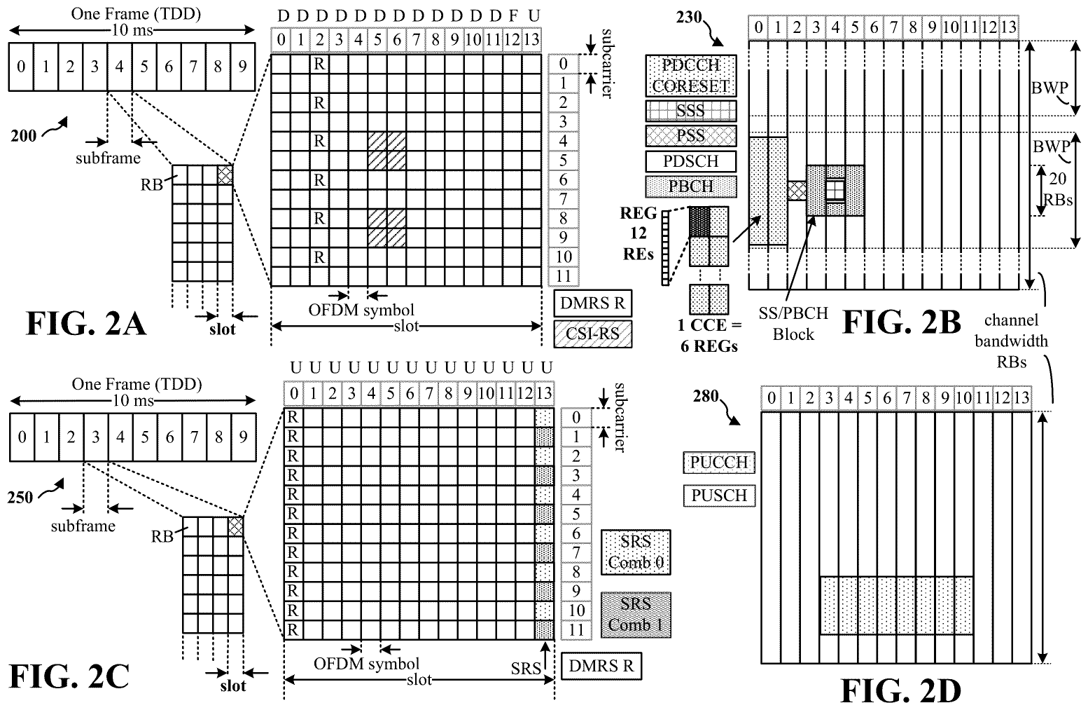

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

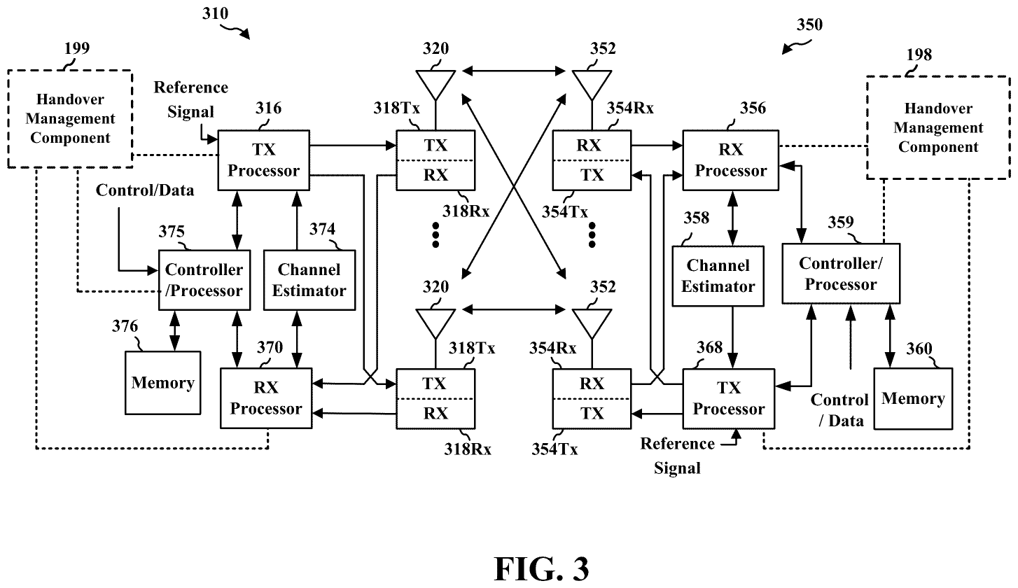

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the handover management component 198 of FIG. 1. At least one of the TX processor 316, the RX processor 370, and the controller/processor 375 may be configured to perform aspects in connection with the handover management component 199 of FIG. 1.

A handover procedure may refer to a procedure of handing over (or transferring) a UE from being served by one cell to being served by another cell. In some aspects, a call of a UE may be in progress during the handover procedure from the serving cell to another cell, e.g., a target cell. The handover procedure may be triggered in response to the UE, e.g., mobile device, moving from one place to another or a change in wireless network connection.

In some aspects, the network, including the base station, may decide to handover a UE from one cell to another may be based on measurement reports received from the UE. That is, based on the measurement reports received from the UE, the base station may decide to handover the UE from a first cell to a second cell. The measurement reports may include multiple measurements of cell metric, e.g., reference signal received power (RSRP), reference signal received quality (RSRQ), signal to interface & noise ratio (SINR), and the signal quality of the serving cell and neighbor cells may be measured using various ways, e.g., periodic measurement or event triggered measurement. That is, to reduce unnecessary handover procedures, the base station and the UE may be configured with a periodic measurement reports and/or an event triggered measurement reports, and the base station and the UE may perform the handover based on the measurement reports.

In some aspects, the event triggered handover procedure may be performed based on the event, which may refer to at least one type of measurement report. The base station may configure the UE with at least one type of events via RRC signaling message. That is, the UE may receive, from the base station, the RRC signaling message including a configuration of the at least one type of events.

In one aspect, the event may correspond to the measurement of the serving cell becoming better than the threshold value, e.g., Event A1, and the ongoing handover procedure may be canceled based on the Event A1. In another aspect, the event may correspond to the measurement of the serving becoming worse than the threshold value, e.g., Event A2, which may trigger a mobility procedure. In another aspect, the event may correspond to the measurement of the neighboring cell becoming an offset value better than the primary cell (PCell), e.g., Event A3, which may trigger an intra-frequency or inter-frequency handover procedures. In another aspect, the event may correspond to the measurement of the neighboring cell becoming better than the threshold value, e.g., Event A4, which may trigger the handover procedures that may not depend upon the coverage of the serving cell. In another aspect, the event may correspond to the measurement of the PCell becoming worse than a first threshold value and the neighboring cell becoming better than a second threshold value, e.g., Event A5, which may trigger the intra-frequency or inter-frequency handover procedures. In another aspect, the event may correspond to the measurement of the neighboring cell becoming an offset value better than the SCell, e.g., Event A6, which may be applicable to carrier aggregation. In another aspect, the event may correspond to the measurement of the inter-radio access technology (RAT) neighboring cell becoming better than the threshold value, e.g., Event B1, which may trigger the inter-RAT handover procedures which does not depend upon the coverage of the serving cell. In another aspect, the event may correspond to the measurement of the PCell becoming worse than a first threshold value and the inter-RAT neighboring cell becoming better than a second threshold value, e.g., Event B2, which may trigger the trigger inter-RAT mobility procedures when the primary serving cell becomes weak.

In some aspects, the UE may find that the measurements of a neighboring cell have fluctuations. The measurements of the neighboring cell may have a significant fluctuation, e.g., fluctuation greater than or equal to the offset of the Event A3, and the base station and the UE may repeat the handover procedure back and forth between the neighboring cell and the serving cell or other cells. In one example, the RSRP measurements of the neighboring cell may swing greater than or equal to at least one threshold value, e.g., the Event A3 offset, the Event A4 threshold value, or the Event A5 threshold values. In response to the fluctuation of the measurements of the neighboring cell, the base station may repeatedly instruct the UE to handover back and forth between the neighboring cell and the other cells including the serving cell. Here, the repeated handovers of the UE between the neighboring cell and the other cells may be referred to as ping-pong handovers, and the neighboring cell may be referred to as a ping-pong handover cell. The ping-pong handover may cause increased dropped calls, interruption of user packet switched data, increased quality degradation, transmission interruption, or other negative impacts on UE throughput and a user experience.

In one aspect, to avoid or reduce the ping-pong handover, the base station and the UE may be configured to blindly overwrite, or increase, the threshold value, e.g., the Event A3 offset, to a different threshold value, e.g., 4 dB, regardless of the occurrence of the ping-pong handover; however, blindly overwriting or increasing the A3 offset may not mitigate the ping-pong handover when the UE RSRP measurement fluctuates greater than the increased A3 offset value. In another aspect, to resolve or mitigate the ping-pong handover, the base station and the UE may be provided with a ping-pong handover detection procedure and may perform a ping-pong handover management (or ping-pong handover avoidance) procedure, which may be triggered by at least one of the Event A3, Event A4, or Event A5.

In some aspects, the base station and the UE may be configured with the ping-pong handover detection aspects and the ping-pong handover management aspects to help avoid a ping-pong effect for handovers at the UE. In some aspects, a unified ping-pong handover detection algorithm may be provided to identify a ping-pong cell and to perform the ping-pong handover management procedure to avoid or reduce the handovers to an identified ping-pong cell. A ping-pong cell may refer to a cell to that is repeatedly a part of back and forth handovers for a UE.

In one aspect, the UE may be configured to perform a unified ping-pong detection algorithm to identify the ping-pong cell. In one example, the UE may maintain a database, e.g., a local database, of the handover history, and the UE may identify the ping-pong cell based on the database and a threshold value (e.g., a threshold number of handover instances involving the cell that indicate a ping-pong handover condition). In some aspects, the threshold value may be independently configured for an intra-frequency handover and an inter-frequency handover. The threshold value for the intra-frequency handover may be the same or different than the inter-frequency handover threshold. In some aspects, the UE may receive, from a base station, an indication of the ping-pong cell candidate and apply an increased weight in performing the ping-pong cell detection for the indicated ping-pong cell candidate.

In another aspect, the UE may be configured to perform a unified ping-pong handover managing to avoid or reduce handover to the identified ping-pong cell. In one example, the unified ping-pong handover managing may include applying a timer and/or a measurement offset to reduce or prevent triggering the event, e.g., transmitting the corresponding measurement report to the base station which may trigger the handover to the identified ping-pong cell. In another example, the UE may be configured to adjust the offset for the measurement of the identified ping-pong cell based on the quality of the serving cell. In another example, the UE may be configured to not trigger the ping-pong handover managing under certain conditions, such as the UE being in a high-speed train mode, using voice over NR (VoNR), or using NR dual connectivity (NRDC).

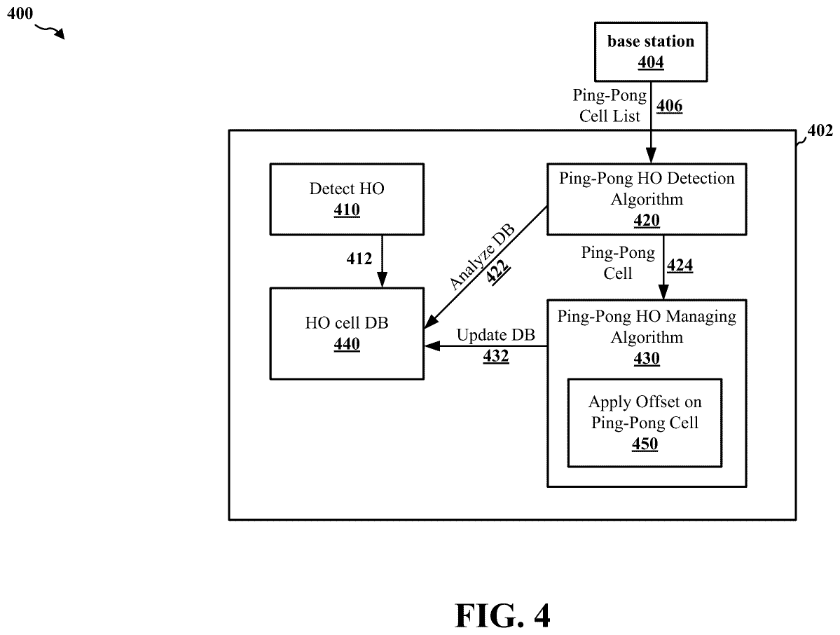

FIG. 4 illustrates a network 400 of wireless communication including the ping-pong handover detection and management. The network 400 may include a UE 402 and a base station 404. The UE 402 and the base station 404 may be configured with one or more components to perform the ping-pong handover detection and the ping-pong handover management. That is, the UE 402 may include a component configured to implement a ping-pong handover detection algorithm 420, a component configured to implement a ping-pong handover managing algorithm 430, and a handover cell database 440. The UE 402 may maintain the handover cell database 440 by recording, analyzing, and updating the handover cell database 440.

At 410, the UE 402 may detect an occurrence of handover from the serving cell to a target cell, and record (412) the information of the detected handover to the handover cell database 440. That is, the UE 402 may record the information of the target cell associated with the detected handover to the handover cell database 440. The UE 402 may include the ping-pong handover detection algorithm 420 which may detect a ping-pong handover based on the handover cell database 440. That is, at 422, the UE 402 may analyze the handover cell database 440 to detect the ping-pong handover and identify the ping-pong cell. The UE 402 may receive a ping-pong cell list 406, e.g., a list of ping-pong cell candidates, from the base station 404, and perform the ping-pong handover detection on the ping-pong cell list 406 with increased weight, e.g., reduced time and/or threshold value.

The ping-pong handover detection algorithm 420 may identify a ping-pong cell, and at 424, the identified ping-pong cell may be introduced to the ping-pong handover managing algorithm 430. At 450, the ping-pong handover managing algorithm 430 may avoid or reduce handover to the identified ping-pong cell by applying an offset on the ping-pong cell. At 432, the ping-pong handover managing algorithm 430 may also update the handover cell database 440 by removing the entries of the pin-pong cell. However, the embodiments are not limited thereto, and the ping-pong handover detection algorithm may be configured to update the handover cell database 440 by removing the entries of the ping-pong cell.

In some aspects, based on detecting the handover from the serving cell to the target cell, the UE may analyze the handover cell database to identify that a number of entries of the target cell in the handover cell database is greater than or equal to a first threshold value within a first period of time. The ping-pong handover detection algorithm may be configured differently for intra-frequency and inter-frequency handover or for different types of handovers.

In one aspect, the UE may detect the ping-pong handover for the intra-frequency handover based on the target cell appearing in the handover cell database for at least a X number of times, including the current handover, in the past T seconds. That is, based on detecting an intra-frequency handover from the serving cell to the target cell, the UE may analyze the handover cell database to identify that the number of entries of the target cell in the handover cell database is greater than or equal to a first threshold value, e.g., X times, within a first period of time, e.g., T seconds. For the intra-frequency handovers, the same cell handover may be excluded from the detection. A same cell handover is a handover in which the source cell and the target cell are the same cell. Also, a blind cell handover may be excluded from the detection because, in the blind cell handover, the base station directly orders or instructs the UE to switch or redirect to the target cell without the UE measuring the adjacent cells. Excluding same cell handovers or blind handovers from the condition detection means that the target cell of a same cell handover or blind handover may be excluded from the count of handover instances that is compared to the threshold in order to detect the handover condition (e.g., the ping-pong handover condition). In one example, the UE may be configured not to record the same cell handover and the blind cell handover into the handover cell database.

In another aspect, the UE may detect the ping-pong handover for the inter-frequency handover based on the target cell appearing in the handover cell database for at least at least Y times, including the current handover, in the past Z seconds. That is, based on detecting an inter-frequency handover from the serving cell to the target cell, the UE may analyze the handover cell database to identify that the number of entries of the target cell in the handover cell database is greater than or equal to a second threshold value, e.g., Y times, within a second period of time, e.g., Z seconds. In one example, a blind cell handover may be excluded from the detection because, in the blind cell handover, the base station directly orders the UE to switch or redirect to the target cell without requiring the UE to measure the adjacent cells. In one example, the UE may be configured not to record the same cell handover and the blind cell handover into the handover cell database.

In some aspects, the intra-frequency ping-pong handover and the inter-frequency ping-pong handover may be detected based on different repeat times, and the UE may apply different offsets on the ping-pong cell for the intra-frequency ping-pong handover and the inter-frequency ping-pong handover. In one aspect, the first threshold value and the first period of time for detecting the ping-pong handover in the intra-frequency handover may be different from the second threshold value and the second period of time for detecting the ping-pong handover in the inter-frequency handover. In another aspect, based on detecting the ping-pong handover, the UE may apply different offsets for the intra-frequency ping-pong handover and the inter-frequency ping-pong handover. That is, the offsets applied to avoid or reduce the ping-pong handovers may be configured differently for the intra-frequency ping-pong handover and the inter-frequency ping-pong handover.

In some aspects, the detection threshold values and the windows of time, e.g., period of time for which the handover instances are compared to the threshold, may be configured for the UE. In other aspects, the threshold values and time period may be determined at the UE. That is, the first threshold value and the first period of time for detecting the ping-pong handover in the intra-frequency handover, the second threshold value and the second period of time for detecting the ping-pong handover in the inter-frequency handover, and the offsets applied to avoid or reduce the ping-pong handovers may be UE configurable. Accordingly, the UE, as well as the base station, may configure the first threshold value and the first period of time for detecting the ping-pong handover and the first offset applied in the intra-frequency handover and the second threshold value and the second period of time for detecting the ping-pong handover and the second offset applied in the inter-frequency handover.

In some aspects, the UE may be configured to relax handover rate criteria including at least one of the detection window or the threshold value based on receiving, from the base station, a list of ping-pong cell candidates. Here, the base station may determine the list of ping-pong cell candidates for the UE. In one example, the base station may determine the list of ping-pong cell candidates based on measurement reports received from the UE or measurement reports received from the other UEs. In one aspect, if the UE determines that the entries of the target cell in the handover cell database meets the relaxed handover rate criteria, the UE may declare that the current handover is a ping-pong handover, e.g., meets a handover condition, and identify that the target cell is the ping-pong cell, e.g., a cell meeting the handover condition. In another aspect, if the UE determines that the entries of the target cell in the handover cell database does not meet the relaxed handover rate criteria, the UE may ignore the list of ping-pong cell candidates received from the base station.

In one aspect, the UE may configure the detection window, e.g., the first period of time for the intra-frequency handover or the second period of time for the inter-frequency handover, based on receiving the list of ping-pong cell candidates from the base station. That is, the UE may relax the detection windows based on receiving, from the base station, a list of ping-pong cell candidates including the target cell. For example, the UE may be configured to identify that the target cell is a ping-pong cell based on detecting 4 entries within 40 seconds, and, in response to receiving the list of ping-pong cell candidates including the target cell from the network, may identify that the target cell is a ping-pong cell based on detecting 4 entries in 60 seconds.

In another aspect, the UE may be configured with, or determine, the threshold value, e.g., the first threshold value for the intra-frequency handover or the second first threshold value for the inter-frequency handover, based on receiving, from the base station, the list of ping-pong cell candidates. That is, the UE may reduce the first threshold value based on receiving the list of ping-pong cell candidates including the target cell from the base station. For example, the UE may be configured to identify that the target cell is a ping-pong cell based on detecting 4 entries within 40 seconds, and, in response to receiving the list of ping-pong cell candidates including the target cell from the network, may identify that the target cell is a ping-pong cell based on detecting 2 entries in 40 seconds.

In another aspect, the UE may be configured with, or determine, both of the detection window and the threshold value based on receiving the list of ping-pong cell candidates from the base station. For example, the UE may be configured to identify that the target cell is a ping-pong cell based on detecting 4 entries within 40 seconds, and, in response to receiving the list of ping-pong cell candidates including the target cell from the network, may identify that the target cell is a ping-pong cell based on detecting 2 entries in 60 seconds.

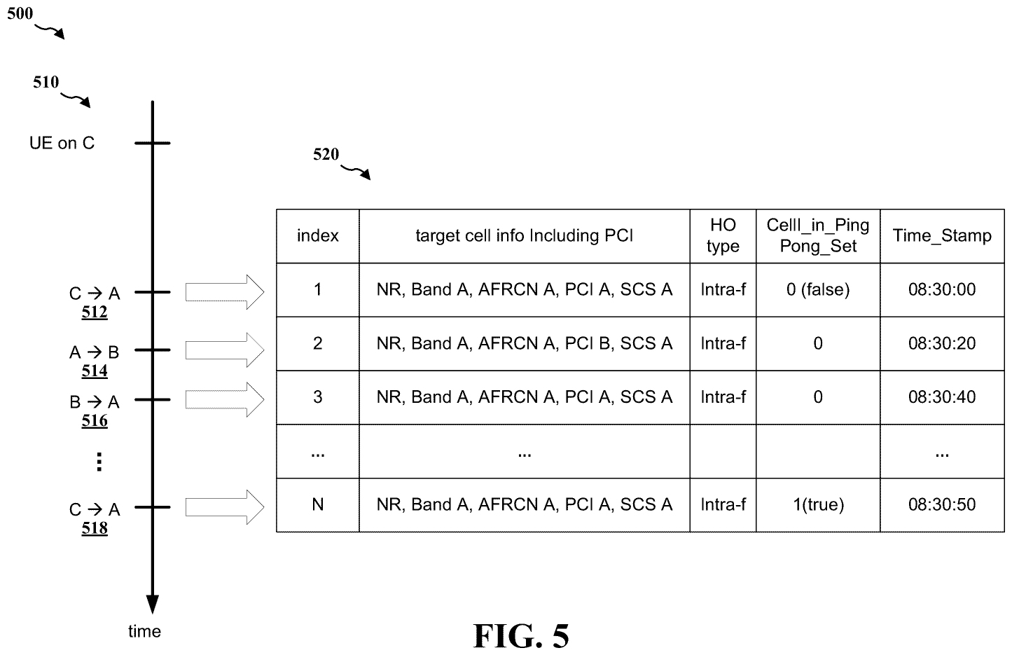

FIG. 5 is a method of wireless communication 500, in accordance with various aspects of the present disclosure. The wireless communication 500 may include a set of handovers 510 and the handover cell database 520, e.g., a ping-pong handover database (PPHO-DB). The handover cell database 520 may include at least one data field including an index, a target cell information, a handover type, an indication of ping-pong handover, or a time stamp. The UE may be configured not to consider a cell global identity (CGI) of the target cell, because the UE may not be aware of the target cell's CGI in an ACQ fail case in an enhanced ultra NR (E-UTRA-NR) Dual Connectivity (ENDC) handover, and communicating a copy of the CGI for the purpose of ping-pong handover detection may be complicated.

In one aspect, the database may be full, and the UE may be configured to remove the entry of the cell with the earliest timestamp index. That is, in case the handover database is filled up to a threshold amount of entries from a continuous operation and handovers, the UE may clear up the database by deleting the target cell entry with the earliest timestamp index in order to create room for future handover entries.

The UE may detect a handover and enter or write an entry of the target cell associated with the detected handover to the handover cell database. In one aspect, in the intra-frequency handover, the entry of the target cell may be added into the handover cell database based on the handover not being a same cell handover or a blind handover. In another aspect, in the inter-frequency handover, the cell may be added into the handover cell database based on the handover not being the blind handover or the same cell handover.

In some aspects, in response to detecting the handover, the ping-pong handover detection algorithm may determine whether the handover is a ping-pong handover. That is, the ping-pong handover detection algorithm may detect the ping-pong handover based on a number of the handover instances to the target cell based on the entries in the handover cell database 520. That is, the ping-pong handover detection algorithm may detect the ping-pong handover based on the handover cell database 520 includes at least a threshold number of entries within a period of time.

For example, the ping-pong handover detection algorithm may be configured to detect ping-pong handover based on identifying three (3) or more target entries in the handover cell database 520 in the past one (1) minute. The UE may first be on a C cell, and a first handover 512 may occur from the C cell to an A cell, and the UE may write the first entry into the handover cell database 520. That is, the UE may write the first entry with the index value 1 in the handover cell database 520, the first entry indicating that the target cell of the first handover 512 is associated with an NR, Band A, absolute radio-frequency channel number (ARFCN) A, PCI A, SCS A, at the time stamp 08:30:00. The ping-pong handover detection algorithm may determine that the first handover 512 is not a ping-pong handover because the handover cell database 520 shows one entry (less than three) of the A cell in the past one minute.

In response to a second handover 514 from the A cell to a B cell, the UE may write the second entry into the handover cell database 520. That is, the UE may write the second entry with the index value 2 in the handover cell database 520, the second entry indicating that the target cell of the second handover 514 is associated with an NR, Band A, absolute radio-frequency channel number (ARFCN) A, PCI B, SCS A, at the time stamp 08:30:20. The ping-pong handover detection algorithm may determine that the second handover 514 is not a ping-pong handover because the handover cell database 520 shows one entry (less than three) of the B cell in the past one minute.

In response to a third handover 516 from the B cell to the A cell, the UE may write the third entry into the handover cell database 520. That is, the UE may write the third entry with the index value 3 in the handover cell database 520, the third entry indicating that the target cell of the third handover 516 is associated with an NR, Band A, absolute radio-frequency channel number (ARFCN) A, PCI A, SCS A, at the time stamp 08:30:40. The ping-pong handover detection algorithm may determine that the third handover 516 is not a ping-pong handover because the handover cell database 520 shows two entries of the A cell in the past one minute.

In response to a N^{th} handover 518 from the C cell to the A cell, the UE may write the Nth entry into the handover cell database 520. That is, the UE may write the N^{th} entry with the index value N in the handover cell database 520, the N^{th} entry indicating that the target cell of the N^{th} handover 518 is associated with an NR, Band A, absolute radio-frequency channel number (ARFCN) A, PCI A, SCS A, at the time stamp 08:30:50. The ping-pong handover detection algorithm may determine that the Ni handover 518 is a ping-pong handover because the handover cell database 520 shows three entries of the A cell in the past one minute, e.g., entries 1, 3, and N. Accordingly, the UE may indicate in the ping-pong handover field that the N^{th} handover 518 is the ping-pong handover.

In response to detecting that a handover procedure, e.g., the N^{th} handover 518, is the ping-pong handover, the UE may identify the target cell of the ping-pong handover as the ping-pong cell, and trigger a ping-pong handover managing algorithm to avoid or reduce the ping-pong handover. Also, in response to identifying the ping-pong cell, the UE may be configured to remove all the entries of the cell from the handover cell database 520. That is, in response to identifying the target cell as the ping-pong cell, the UE may trigger the ping-pong handover managing algorithm on the ping-pong cell and restart the ping-pong handover detection entry on the ping-pong cell.

For example, in response to determining that the N^{th} handover 518 is the ping-pong handover and identifying that the A cell is the ping-pong cell, the UE may trigger the ping-pong handover managing algorithm on the A cell, and remove all the entries of the A cell from the handover cell database 520. That is, the UE may remove entries 1, 3, and N based on identifying the ping-pong handover and applying the ping-pong handover managing algorithm on the A cell.

In some aspects, the UE may maintain the handover cell database 520 in both of the RRC idle state and the RRC connected state, to avoid ping-pong handover again after the UE switch from the RRC connected state to the RRC idle state then back to the RRC connected state again. That is, the UE may keep maintaining the handover cell database 520 in the RRC idle state as well as the RRC connected state, and the UE may prevent or reduce ping-pong handovers during switching between the RRC connected state and the RRC idle state. The ping-pong handover managing algorithm may be applied to the measurement report evaluation, and prevent or reduce triggering of the event that may trigger the handover to the identified ping-pong cell.

Upon detecting the ping-pong handover, the UE may start a ping-pong handover avoidance timer H_{A}. In one aspect, the ping-pong handover avoidance timer H_{A} may be UE configurable. While the ping-pong handover avoidance timer H_{A} is running, the UE may apply the ping-pong handover managing algorithm on the ping-pong cell during the measurement report evaluation.

The ping-pong handover managing algorithm may be provided to prevent or reduce the ping-pong handovers to the identified ping-pong cell by applying an additional offset towards the measurement of the ping-pong cell. That is, in response to indicating the ping-pong cell, the ping-pong handover managing algorithm may apply additional offset to the RSRP measurement of the ping-pong cell so that the RSRP measurement of the ping-pong cell may not trigger the ping-pong handover to the identified ping-pong cell. In one aspect, the ping-pong handover managing algorithm may be configured not to apply the additional offset based on the UE is in a particular mode, such as the high-speed train (HST) mode and/or VoNR/NRDC.

In some aspects, the ping-pong handover managing algorithm may be configured differently for the intra-frequency and the inter-frequency handover. In one aspect, for the intra-frequency ping-pong cell, the UE may additionally apply the intra-frequency offset towards measured RSRP of the cell if UE not in the HST or the VoNR/NRDC, because the UE in the HST or the VoNR/NRDC may drop ongoing call when an additional offset is applied to the measurements of the target cells. The intra-frequency offset may be configured based on an edge and fog computing system (EFS) configurable intra-frequency parameter and can be adjustable per the ping-pong cell's power. In another aspect, for the inter-frequency ping-pong cell, the UE may additionally apply the inter-frequency offset towards measured RSRP of the cell if UE not in the HST or the VoNR/NRDC. The inter-frequency offset may be configured based on an EFS configurable inter-frequency parameter and can be adjustable per the ping-pong cell's power. The ping-pong handover may be seen more frequently on the intra-frequency due to the cell deployment and the intra-frequency interference, and the ping-pong handover managing algorithm may apply a greater offset to the intra-frequency handover.

In one example, for the intra-frequency ping-pong handover, if the RSRP of the ping-pong cell is greater than −80 dBm, the intra-frequency offset may be set to 10 dB (the cell RSRP>−80 dBm, intra-f-offset=10 dB). If the RSRP of the ping-pong cell is smaller than or equal to −80 dBm and greater than −90 dBm, the intra-frequency offset may be set to 8 dB (else if the cell RSRP>−90 dbm, intra-f-offset=8 dB). If the RSRP of the ping-pong cell is smaller than or equal to −90 dBm and greater than −105 dBm, the intra-frequency offset may be set to 6 dB (else if the cell RSRP>−105 dbm, intra-f-offset=6 dB). If the RSRP of the ping-pong cell is smaller than or equal to −105 dBm, the intra-frequency offset may be set to a default value. (else offset=OTA value)

In another example, for the inter-frequency ping-pong handover, if the RSRP of the ping-pong cell is greater than −80 dBm, the inter-frequency offset may be set to 8 dB (the cell RSRP>−80 dBm, inter-f-offset=8 dB). If the RSRP of the ping-pong cell is smaller than or equal to −80 dBm and greater than −90 dBm, the inter-frequency offset may be set to 8 dB (else if the cell RSRP>−90 dbm, inter-f-offset=6 dB). If the RSRP of the ping-pong cell is smaller than or equal to −90 dBm and greater than −105 dBm, the inter-frequency offset may be set to 6 dB (else if the cell RSRP>−105 dbm, inter-f-offset=4 dB). If the RSRP of the ping-pong cell is smaller than or equal to −105 dBm, the inter-frequency offset may be set to a default value. (else offset=OTA value)

The ping-pong handover detection algorithm and the ping-pong handover managing algorithm may be applied on a sub-6 GHz primary component carrier (PCC) cell handover for the NR standalone (SA) (NRSA) or the ENDC. In some aspects, the ping-pong handover detection algorithm and the ping-pong handover managing algorithm may not be applied to handovers if the UE is in one or more modes, such as the HST, VoNR, or NRDC. In one aspect, if the target cell is already added to the handover cell database, the UE entering the HST, VoNR, or NRDC may activate the ping-pong handover avoidance timer H_{A}, but may not apply the additional offset of the ping-pong handover managing algorithm while letting the ping-pong handover avoidance timer H_{A} run and expire.

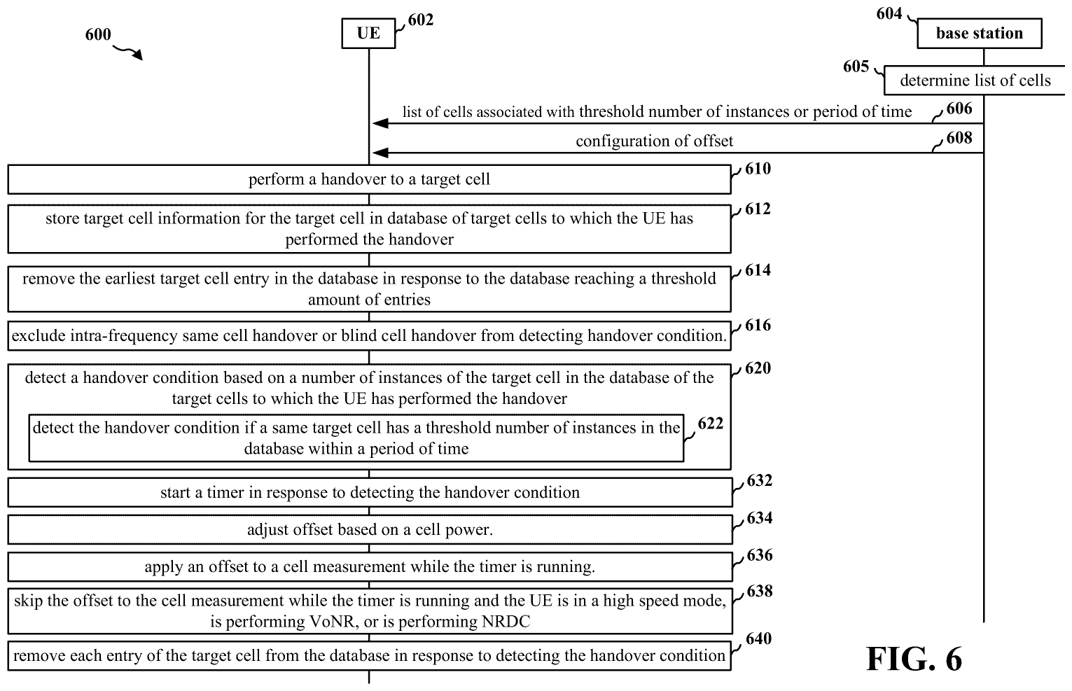

FIG. 6 is a call-flow diagram 600 of a method of wireless communication. The call-flow diagram 600 may include a UE 602 and a base station (or a network node) 604. The UE 602 may detect a ping-pong handover and identify the target cell of the ping-pong handover as a ping-pong cell. To detect the ping-pong handover, the UE 602 may maintain a database, e.g., a handover target cell database, by storing the target cell information based on performing a handover, and detect the ping-pong condition based on a number of handover instances in the database of the target cell to which the UE 602 has performed the handover being greater than or equal to a threshold number of the handover instances within a period of time. The UE 602 may receive, from a base station 604, a list of cells, e.g., a list of ping-pong cell candidates, and adjust the number of handover instances of the target cell and/or the period of time based on the list of ping-pong cell candidates received from the base station 604. The UE 602 may avoid or reduce the handover to the identified ping-pong cell based on the detected ping-pong handover by applying an offset to the measurement of the target cell.

At 605, the base station 604 may determine a list of cells, e.g., a list of ping-pong cell candidates, that are candidates for a handover condition. Here, the handover condition may include the ping-pong handover. In one example, the base station 604 may determine the list of ping-pong cell candidates based on measurement reports received from the UE 602 or measurement reports received from the other UEs.

At 606, the base station 604 may transmit the list of cells associated with at least one of a threshold number of instances of a target cell or a period of time for detecting a handover condition. That is, the base station 604 may transmit the list of ping-pong cell candidates determined at 605 to the UE 602, and the list of cells may be associated with at least one of the threshold number of instances of a target cell or the period of time for detecting the handover condition. The UE 602 may receive the list of cells associated with at least one of the threshold number of instances or the period of time, and configure the threshold number of instances or the period of time at 622 based on the received list of cells.

At 608, the base station 604 may transmit a configuration of an offset for the UE 602 to apply to a measurement of the target cell to exclude the target cell from a handover decision in response to detecting the handover condition, e.g., the ping-pong handover. The UE 602 may receive the configuration of the offset and apply the offset to the measurement of the target cell to exclude the target cell from a handover decision in response to detecting the handover condition, e.g., the ping-pong handover, and configure the offset to be applied to the cell measurement at 636.

At 610, the UE 602 may perform a handover to a target cell. Here, the handover to the target cell may be based on an event triggered measurement reports of the serving cell and/or at least one neighboring cell, e.g., Event A3, Event A4, or Event A5. Here, the UE 602 may detect and perform a handover from the serving cell to a target cell, and record the information of the target cell associated with the detected handover to the handover cell database.

At 612, the UE 602 may store target cell information for the target cell in database of target cells to which the UE 602 has performed the handover. In one aspect, the target cell information may be stored in the database based on at least one of the handover being an intra-frequency handover that is not a same cell handover or a blind handover, or the handover being an inter-frequency handover that is not the blind handover.

In another aspect, the database of the target cells to which the UE 602 has performed the handover may be maintained while the UE 602 is in an RRC idle state and an RRC connected state. That is, the UE 602 may keep maintaining the handover cell database 520 in the RRC idle state as well as the RRC connected state, and the UE 602 may prevent or reduce ping-pong handovers during switching between the RRC connected state and the RRC idle state.

In another aspect, the target cell information stored in the database is independent of a CGI. The UE 602 may not be aware of the target cell's CGI in a particular scenario, e.g., in an ACQ fail case in an ENDC handover, and communicating a copy of the CGI for the purpose of ping-pong handover detection may be complicated.

At 614, the UE 602 may remove an earliest target cell entry in the database in response to the database reaching a threshold amount of entries. When the database reaches the threshold amount of entries, e.g., full size, and the UE 602 may be configured to clear up the database by removing the entry of the cell with the earliest timestamp index.

At 616, the UE 602 may exclude an intra-frequency same cell handover or a blind cell handover from detecting the handover condition. The blind cell handover may be excluded from the detection because, in the blind cell handover, the base station 604 directly instructs the UE 602 to handover to the target cell without the UE 602 measuring the adjacent cells.

At 620, the UE 602 may detect a handover condition based on a number of instances of the target cell in the database of the target cells to which the UE 602 has performed the handover. Here, the handover condition may include the ping-pong handover. The UE 602 may include a ping-pong handover detection algorithm, which may detect a ping-pong handover based on the database. Here, 620 may include 622.

At 622, the UE 602 may detect the handover condition if a same target cell has a threshold number of instances in the database within a period of time. That is, the ping-pong handover detection algorithm of the UE 602 may be configured to detect the ping-pong handover based on a number of entries of the target cell in the handover cell database is greater than or equal to a first threshold value within a first period of time.

In one aspect, at least one of the threshold number of instances or the period of time may be different for an intra-frequency handover condition and an inter-frequency handover condition. That is, the ping-pong handover detection algorithm may be configured differently for the intra-frequency and the inter-frequency handover. For example, the first threshold value and the first period of time for detecting the ping-pong handover in the intra-frequency handover may be different from the second threshold value and the second period of time for detecting the ping-pong handover in the inter-frequency handover.

In another aspect, the detection threshold values and the detection windows may be UE configurable. That is, the first threshold value and the first period of time for detecting the ping-pong handover in the intra-frequency handover and the second threshold value and the second period of time for detecting the ping-pong handover in the inter-frequency handover may be UE configurable.

In another aspect, the UE 602 may apply an increased weight, e.g., reduced detection window and/or threshold value, to perform the ping-pong handover detection on the list of cells received from the base station 604 at 606. That is, the UE 602 may be configured to relax handover rate criteria including at least one of the detection window or the threshold value based on receiving, from the base station 604, a list of cells at 606. For example, the UE 602 may be configured to identify that the target cell is a ping-pong cell based on detecting 4 entries in the database within 40 seconds, and, in response to receiving the list of cells including the target cell from the network at 606, may identify that the target cell is a ping-pong cell based on detecting a reduced number of entries, e.g., 2 entries and/or in a longer period of time, e.g., 60 seconds.

The UE 602 may include a ping-pong handover managing algorithm, and based on the ping-pong handover detection algorithm identifying the ping-pong handover, the UE 602 may introduce the ping-pong cell, e.g., the target cell, associated with the ping-pong handover to the ping-pong handover managing algorithm to avoid or reduce the handover to the target cell. In response to indicating the ping-pong cell, the ping-pong handover managing algorithm may apply additional offset to the RSRP measurement of the ping-pong cell so that the RSRP measurement of the ping-pong cell may not trigger the ping-pong handover to the identified ping-pong cell.

At 632, the UE 602 may start a timer in response to detecting the handover condition. Upon detecting the ping-pong handover, the UE 602 may start a ping-pong handover avoidance timer H_{A}. In one aspect, the ping-pong handover avoidance timer H_{A} may be UE configurable. While the ping-pong handover avoidance timer H_{A} is running, the UE 602 may apply the ping-pong handover managing algorithm on the ping-pong cell during the measurement report evaluation.

At 634, the UE 602 may adjust the offset based on a cell power of the target cell. That is, the offset to be applied to the measurement of the target cell may be determined based on the measured cell power of the target cell. In one example, for the intra-frequency ping-pong handover, the offset may be set to 10 db for the RSRP of the target cell being greater than −80 dbm, 8 dB for the RSRP of the target cell being smaller than or equal to −80 dBm and greater than −90 dBm, 6 dB for the RSRP of the target cell being smaller than or equal to −90 dBm and greater than −105 dBm, or a default value based on the RSRP of the target cell being smaller than or equal to −105 dBm. In another example, for the inter-frequency ping-pong handover, the offset may be set to 8 dB for the RSRP of the target cell being greater than −80 dbm, 6 dB for the RSRP of the target cell being smaller than or equal to −80 dBm and greater than −90 dBm, 4 dB for the RSRP of the target cell being smaller than or equal to −90 dBm and greater than −105 dBm, or a default value based on the RSRP of the target cell being smaller than or equal to −105 dBm.

At 636, the UE 602 may apply an offset to a cell measurement while the timer is running. That is, the ping-pong handover managing algorithm may be provided to prevent or reduce the ping-pong handovers to the identified ping-pong cell by applying an additional offset towards the measurement of the ping-pong cell. Here, the offset may be configured based on the configuration of the offset received from the base station 604 at 608. In one aspect, the cell measurement may include an RSRP measurement. The offset may be different for an intra-frequency handover measurement and an inter-frequency handover measurement. That is, the UE 602 may apply different offsets for the intra-frequency ping-pong handover and the inter-frequency ping-pong handover. The offsets applied to avoid or reduce the ping-pong handovers may be configured differently for the intra-frequency ping-pong handover and the inter-frequency ping-pong handover. For example, the ping-pong handover managing algorithm may apply a greater offset to the intra-frequency handover.

At 638, the UE 602 may skip the offset to the cell measurement while the timer is running and the UE 602 is in a high speed mode, is performing the VoNR, or is performing the NRDC. That is, the ping-pong handover managing algorithm of the UE 602 may be configured not to apply the additional offset based on the UE 602 in the HST mode and/or VoNR/NRDC The UE 602 in the HST or the VoNR/NRDC may drop the ongoing call when an additional offset is applied to the measurements of the target cells.

At 640, the UE 602 may remove each entry of the target cell from the database in response to detecting the handover condition. That is, in response to detecting the ping-pong handover and identifying the target cell as the ping-pong cell, the UE 602 may trigger the ping-pong handover managing algorithm on the target cell, and remove all the entries of the A cell from the database of the target cells to which the UE 602 has performed the handover.

In some aspects, the ping-pong handover detection algorithm and the ping-pong handover managing algorithm may be applied on a sub-6 GHz PCC cell handover. For example, the ping-pong handover detection algorithm and the ping-pong handover managing algorithm may be applied on the sub-6 GHz PCC cell handover for the NRSA or the ENDC.

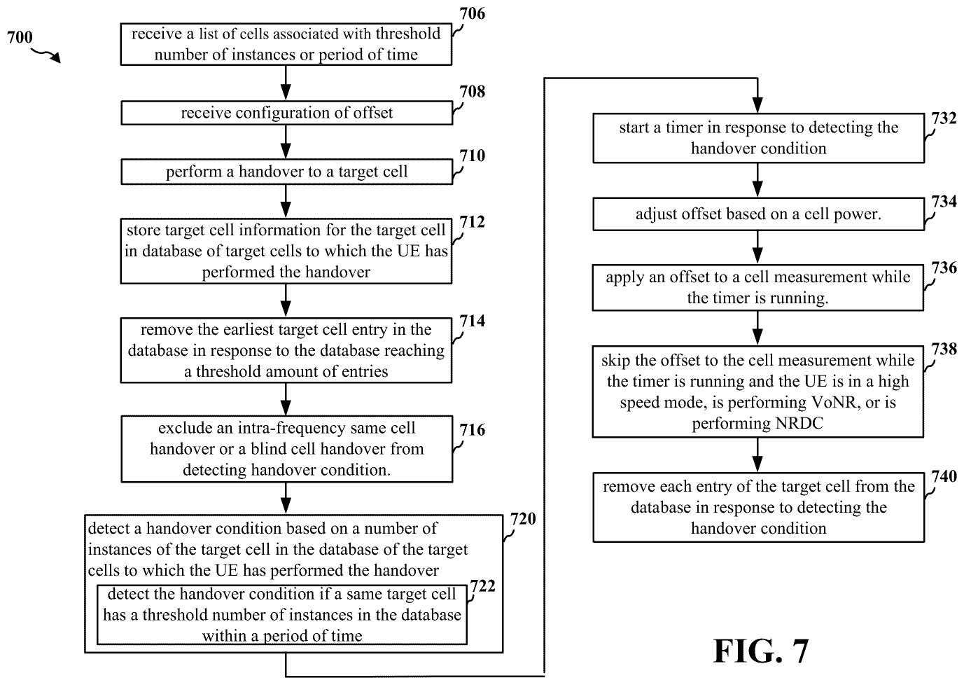

FIG. 7 is a flowchart 700 of a method of wireless communication. The method may be performed by a UE (e.g., the UE 104; the apparatus 1104). The UE may detect a ping-pong handover and identify the target cell of the ping-pong handover as a ping-pong cell. To detect the ping-pong handover, the UE may maintain a database, e.g., a handover target cell database, by storing the target cell information based on performing a handover, and detect the ping-pong condition based on a number of handover instances in the database of the target cell to which the UE has performed the handover being greater than or equal to a threshold number of the handover instances within a period of time. The UE may receive, from a base station, a list of cells, e.g., a list of ping-pong cell candidates, and adjust the number of handover instances of the target cell and/or the period of time based on the list of ping-pong cell candidates received from the base station. The UE may avoid or reduce the handover to the identified ping-pong cell based on the detected ping-pong handover by applying an offset to the measurement of the target cell.

At 706, the UE may receive a list of cells associated with at least one of the threshold number of instances or the period of time. Here, the UE may configure the threshold number of instances or the period of time at 722 based on the received list of cells. For example, at 606, the UE 602 may receive, from the base station 604, a list of cells associated with at least one of the threshold number of instances or the period of time. Furthermore, 706 may be performed by a handover management component 198.

At 708, the UE may receive a configuration of the offset and apply the offset to the measurement of the target cell to avoid or reduce handover to the target cell in response to detecting the handover condition. Here, the handover condition may include the ping-pong handover, and the UE may configure the offset to be applied to the cell measurement at 736. For example, at 608, the UE 602 may receive the configuration of the offset and apply the offset to the measurement of the target cell to avoid or reduce handover to the target cell in response to detecting the handover condition. Furthermore, 708 may be performed by the handover management component 198.

At 710, the UE may perform a handover to a target cell. Here, the handover to the target cell may be based on an event triggered measurement reports of the serving cell and/or at least one neighboring cell, e.g., Event A3, Event A4, or Event A5. Here, the UE may detect and perform a handover from the serving cell to a target cell, and record the information of the target cell associated with the detected handover to the handover cell database. For example, at 610, the UE 602 may perform a handover to a target cell. Furthermore, 710 may be performed by the handover management component 198.

At 712, the UE may store target cell information for the target cell in database of target cells to which the UE has performed the handover. In one aspect, the target cell information may be stored in the database based on at least one of the handover being an intra-frequency handover that is not a same cell handover or a blind handover, or the handover being an inter-frequency handover that is not the blind handover. In another aspect, the database of the target cells to which the UE has performed the handover may be maintained while the UE is in an RRC idle state and an RRC connected state. That is, the UE may keep maintaining the handover cell database 520 in the RRC idle state as well as the RRC connected state, and the UE may prevent or reduce ping-pong handovers during switching between the RRC connected state and the RRC idle state. In another aspect, the target cell information stored in the database is independent of a CGI. The UE may not be aware of the target cell's CGI in a particular scenario, e.g., in an ACQ fail case in an ENDC handover, and communicating a copy of the CGI for the purpose of ping-pong handover detection may be complicated. For example, at 612, the UE 602 may store target cell information for the target cell in database of target cells to which the UE 602 has performed the handover. Furthermore, 712 may be performed by the handover management component 198.

At 714, the UE may remove an earliest target cell entry in the database in response to the database reaching a threshold amount of entries. When the database reaches the threshold amount of entries, e.g., full size, and the UE may be configured to clear up the database by removing the entry of the cell with the earliest timestamp index. For example, at 614, the UE 602 may remove an earliest target cell entry in the database in response to the database reaching a threshold amount of entries. Furthermore, 714 may be performed by the handover management component 198.

At 716, the UE may exclude an intra-frequency same cell handover or a blind cell handover from detecting the handover condition. The blind cell handover may be excluded from the detection because, in the blind cell handover, the base station directly instructs the UE to handover to the target cell without the UE measuring the adjacent cells. For example, at 616, the UE 602 may exclude an intra-frequency same cell handover or a blind cell handover from detecting the handover condition. Furthermore, 716 may be performed by a handover management component 198.

At 720, the UE may detect a handover condition based on a number of instances of the target cell in the database of the target cells to which the UE has performed the handover. Here, the handover condition may include the ping-pong handover. The UE may include a ping-pong handover detection algorithm, which may detect a ping-pong handover based on the database. Here, 720 may include 722. For example, at 620, the UE 602 may detect a handover condition based on a number of instances of the target cell in the database of the target cells to which the UE 602 has performed the handover. Furthermore, 720 may be performed by the handover management component 198.

At 722, the UE may detect the handover condition if a same target cell has a threshold number of instances in the database within a period of time. That is, the ping-pong handover detection algorithm of the UE may be configured to detect the ping-pong handover based on a number of entries of the target cell in the handover cell database is greater than or equal to a first threshold value within a first period of time. In one aspect, at least one of the threshold number of instances or the period of time may be different for an intra-frequency handover condition and an inter-frequency handover condition. That is, the ping-pong handover detection algorithm may be configured differently for the intra-frequency and the inter-frequency handover. For example, the first threshold value and the first period of time for detecting the ping-pong handover in the intra-frequency handover may be different from the second threshold value and the second period of time for detecting the ping-pong handover in the inter-frequency handover. In another aspect, the detection threshold values and the detection windows may be UE configurable. That is, the first threshold value and the first period of time for detecting the ping-pong handover in the intra-frequency handover and the second threshold value and the second period of time for detecting the ping-pong handover in the inter-frequency handover may be UE configurable. In another aspect, the UE may apply an increased weight, e.g., reduced detection window and/or threshold value, to perform the ping-pong handover detection on the list of cells received from the base station at 706. That is, the UE may be configured to relax handover rate criteria including at least one of the detection window or the threshold value based on receiving, from the base station, a list of cells at 706. For example, the UE may be configured to identify that the target cell is a ping-pong cell based on detecting 4 entries in the database within 40 seconds, and, in response to receiving the list of cells including the target cell from the network at 706, may identify that the target cell is a ping-pong cell based on detecting a reduced number of entries, e.g., 2 entries and/or in a longer period of time, e.g., 60 seconds. For example, at 622, the UE 602 may detect the handover condition if a same target cell has a threshold number of instances in the database within a period of time. Furthermore, 722 may be performed by the handover management component 198.

The UE may include a ping-pong handover managing algorithm, and based on the ping-pong handover detection algorithm identifying the ping-pong handover, the UE may introduce the ping-pong cell, e.g., the target cell, associated with the ping-pong handover to the ping-pong handover managing algorithm to avoid or reduce the handover to the target cell. In response to indicating the ping-pong cell, the ping-pong handover managing algorithm may apply additional offset to the RSRP measurement of the ping-pong cell so that the RSRP measurement of the ping-pong cell may not trigger the ping-pong handover to the identified ping-pong cell.

At 732, the UE may start a timer in response to detecting the handover condition. Upon detecting the ping-pong handover, the UE may start a ping-pong handover avoidance timer H_{A}. In one aspect, the ping-pong handover avoidance timer H_{A} may be UE configurable. While the ping-pong handover avoidance timer H_{A} is running, the UE may apply the ping-pong handover managing algorithm on the ping-pong cell during the measurement report evaluation. For example, at 632, the UE 602 may start a timer in response to detecting the handover condition. Furthermore, 732 may be performed by the handover management component 198.

At 734, the UE may adjust the offset based on a cell power of the target cell. That is, the offset to be applied to the measurement of the target cell may be determined based on the measured cell power of the target cell. In one example, for the intra-frequency ping-pong handover, the offset may be set to 10 db for the RSRP of the target cell being greater than −80 dbm, 8 dB for the RSRP of the target cell being smaller than or equal to −80 dBm and greater than −90 dBm, 6 dB for the RSRP of the target cell being smaller than or equal to −90 dBm and greater than −105 dBm, or a default value based on the RSRP of the target cell being smaller than or equal to −105 dBm. In another example, for the inter-frequency ping-pong handover, the offset may be set to 8 dB for the RSRP of the target cell being greater than −80 dbm, 6 dB for the RSRP of the target cell being smaller than or equal to −80 dBm and greater than −90 dBm, 4 dB for the RSRP of the target cell being smaller than or equal to −90 dBm and greater than −105 dBm, or a default value based on the RSRP of the target cell being smaller than or equal to −105 dBm. For example, at 634, the UE 602 may adjust the offset based on a cell power of the target cell. Furthermore, 734 may be performed by the handover management component 198.

At 736, the UE may apply an offset to a cell measurement while the timer is running. That is, the ping-pong handover managing algorithm may be provided to prevent or reduce the ping-pong handovers to the identified ping-pong cell by applying an additional offset towards the measurement of the ping-pong cell. Here, the offset may be configured based on the configuration of the offset received from the base station at 708. In one aspect, the cell measurement may include an RSRP measurement. The offset may be different for an intra-frequency handover measurement and an inter-frequency handover measurement. That is, the UE may apply different offsets for the intra-frequency ping-pong handover and the inter-frequency ping-pong handover. The offsets applied to avoid or reduce the ping-pong handovers may be configured differently for the intra-frequency ping-pong handover and the inter-frequency ping-pong handover. For example, the ping-pong handover managing algorithm may apply a greater offset to the intra-frequency handover. For example, at 636, the UE 602 may apply an offset to a cell measurement while the timer is running. Furthermore, 736 may be performed by a handover management component 198.

At 738, the UE may skip the offset to the cell measurement while the timer is running and the UE is in a high speed mode, is performing the VoNR, or is performing the NRDC. That is, the ping-pong handover managing algorithm of the UE may be configured not to apply the additional offset based on the UE in the HST mode and/or VoNR/NRDC The UE in the HST or the VoNR/NRDC may drop the ongoing call when an additional offset is applied to the measurements of the target cells. For example, at 638, the UE 602 may skip the offset to the cell measurement while the timer is running and the UE 602 is in a high speed mode, is performing the VoNR, or is performing the NRDC. Furthermore, 738 may be performed by the handover management component 198.

At 740, the UE may remove each entry of the target cell from the database in response to detecting the handover condition. That is, in response to detecting the ping-pong handover and identifying the target cell as the ping-pong cell, the UE may trigger the ping-pong handover managing algorithm on the target cell, and remove all the entries of the A cell from the database of the target cells to which the UE has performed the handover. For example, at 640, the UE 602 may remove each entry of the target cell from the database in response to detecting the handover condition. Furthermore, 740 may be performed by the handover management component 198.

In some aspects, the ping-pong handover detection algorithm and the ping-pong handover managing algorithm may be applied on a sub-6 GHz PCC cell handover. For example, the ping-pong handover detection algorithm and the ping-pong handover managing algorithm may be applied on the sub-6 GHz PCC cell handover for the NRSA or the ENDC.

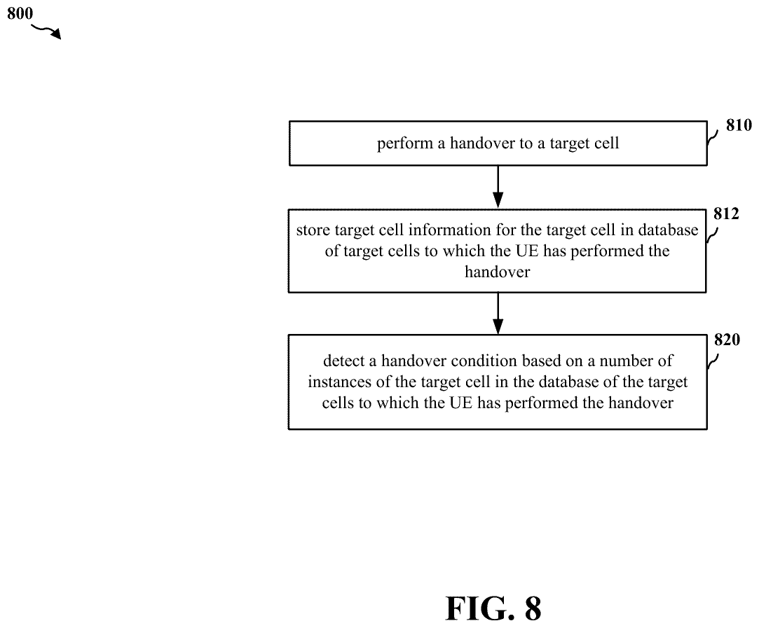

FIG. 8 is a flowchart 800 of a method of wireless communication. The method may be performed by a UE (e.g., the UE 104; the apparatus 1104). The UE may detect a ping-pong handover and identify the target cell of the ping-pong handover as a ping-pong cell. To detect the ping-pong handover, the UE may maintain a database, e.g., a handover target cell database, by storing the target cell information based on performing a handover, and detect the ping-pong condition based on a number of handover instances in the database of the target cell to which the UE has performed the handover being greater than or equal to a threshold number of the handover instances within a period of time. The UE may receive, from a base station, a list of cells, e.g., a list of ping-pong cell candidates, and adjust the number of handover instances of the target cell and/or the period of time based on the list of ping-pong cell candidates received from the base station. The UE may avoid or reduce the handover to the identified ping-pong cell based on the detected ping-pong handover by applying an offset to the measurement of the target cell.

At 810, the UE may perform a handover to a target cell. Here, the handover to the target cell may be based on an event triggered measurement reports of the serving cell and/or at least one neighboring cell, e.g., Event A3, Event A4, or Event A5. Here, the UE may detect and perform a handover from the serving cell to a target cell, and record the information of the target cell associated with the detected handover to the handover cell database. For example, at 610, the UE 602 may perform a handover to a target cell. Furthermore, 810 may be performed by the handover management component 198.

At 812, the UE may store target cell information for the target cell in database of target cells to which the UE has performed the handover. In one aspect, the target cell information may be stored in the database based on at least one of the handover being an intra-frequency handover that is not a same cell handover or a blind handover, or the handover being an inter-frequency handover that is not the blind handover. In another aspect, the database of the target cells to which the UE has performed the handover may be maintained while the UE is in an RRC idle state and an RRC connected state. That is, the UE may keep maintaining the handover cell database 520 in the RRC idle state as well as the RRC connected state, and the UE may prevent or reduce ping-pong handovers during switching between the RRC connected state and the RRC idle state. In another aspect, the target cell information stored in the database is independent of a CGI. The UE may not be aware of the target cell's CGI in a particular scenario, e.g., in an ACQ fail case in an ENDC handover, and communicating a copy of the CGI for the purpose of ping-pong handover detection may be complicated. For example, at 612, the UE 602 may store target cell information for the target cell in database of target cells to which the UE 602 has performed the handover. Furthermore, 812 may be performed by the handover management component 198.

At 820, the UE may detect a handover condition based on a number of instances of the target cell in the database of the target cells to which the UE has performed the handover. Here, the handover condition may include the ping-pong handover. The UE may include a ping-pong handover detection algorithm, which may detect a ping-pong handover based on the database. Here, 820 may include 822. For example, at 620, the UE 602 may detect a handover condition based on a number of instances of the target cell in the database of the target cells to which the UE 602 has performed the handover. Furthermore, 820 may be performed by the handover management component 198.

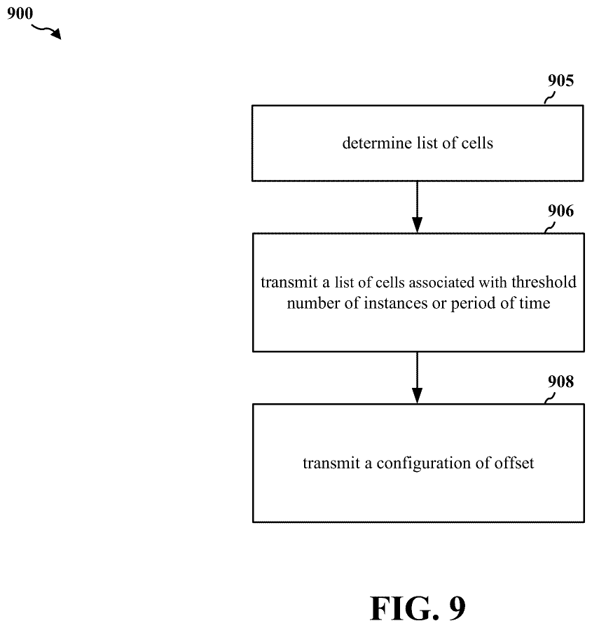

FIG. 9 is a flowchart 900 of a method of wireless communication. The method may be performed by a base station (e.g., the base station 102; the network entity 1102). The base station may determine a list of cells, e.g., a list of ping-pong cell candidates, and transmit the list of cells to the UE, for the UE, transmit the list of cells for the UE to detect the ping-pong handover, and transmit a configuration of an offset for the UE to apply the offset to the measurement of the target cell to avoid ping-pong handover.

At 905, the base station may determine a list of cells, e.g., a list of ping-pong cell candidates, that are candidates for a handover condition. Here, the handover condition may include the ping-pong handover. In one example, the base station 604 may determine the list of ping-pong cell candidates based on measurement reports received from the UE 602 or measurement reports received from the other UEs. For example, at 605, the base station 604 may determine a list of cells, e.g., a list of ping-pong cell candidates, that are candidates for a handover condition. Furthermore, 905 may be performed by a handover management component 199.

At 906, the base station may transmit the list of cells associated with at least one of a threshold number of instances of a target cell or a period of time for detecting a handover condition. That is, the base station may transmit the list of ping-pong cell candidates determined at 905 to the UE, and the list of cells may be associated with at least one of the threshold number of instances of a target cell or the period of time for detecting the handover condition. The UE may receive the list of cells associated with at least one of the threshold number of instances or the period of time, and configure the threshold number of instances or the period of time based on the received list of cells. For example, at 606, the base station 604 may transmit the list of cells associated with at least one of a threshold number of instances of a target cell or a period of time for detecting a handover condition. Furthermore, 906 may be performed by a handover management component 199.

At 908, the base station may transmit a configuration of an offset for the UE to apply to a measurement of the target cell to exclude the target cell from a handover decision in response to detecting the handover condition, e.g., the ping-pong handover. For example, at 608, the base station 604 may transmit a configuration of an offset for the UE 602 to apply to a measurement of the target cell to exclude the target cell from a handover decision in response to detecting the handover condition, e.g., the ping-pong handover. Furthermore, 908 may be performed by the handover management component 199.

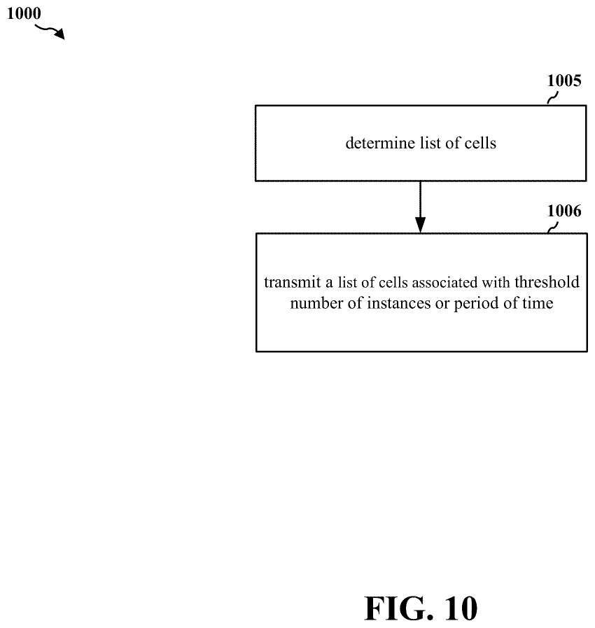

FIG. 10 is a flowchart 1000 of a method of wireless communication. The method may be performed by a base station (e.g., the base station 102; the network entity 1102). The base station may determine a list of cells, e.g., a list of ping-pong cell candidates, and transmit the list of cells to the UE, for the UE, transmit the list of cells for the UE to detect the ping-pong handover, and transmit a configuration of an offset for the UE to apply the offset to the measurement of the target cell to avoid ping-pong handover.

At 1005, the base station may determine a list of cells, e.g., a list of ping-pong cell candidates, that are candidates for a handover condition. Here, the handover condition may include the ping-pong handover. In one example, the base station 604 may determine the list of ping-pong cell candidates based on measurement reports received from the UE 602 or measurement reports received from the other UEs. For example, at 605, the base station 604 may determine a list of cells, e.g., a list of ping-pong cell candidates, that are candidates for a handover condition. Furthermore, 1005 may be performed by a handover management component 199.

At 1006, the base station may transmit the list of cells associated with at least one of a threshold number of instances of a target cell or a period of time for detecting a handover condition. That is, the base station may transmit the list of ping-pong cell candidates determined at 1005 to the UE, and the list of cells may be associated with at least one of the threshold number of instances of a target cell or the period of time for detecting the handover condition. The UE may receive the list of cells associated with at least one of the threshold number of instances or the period of time, and configure the threshold number of instances or the period of time based on the received list of cells. For example, at 606, the base station 604 may transmit the list of cells associated with at least one of a threshold number of instances of a target cell or a period of time for detecting a handover condition. Furthermore, 1006 may be performed by a handover management component 199.

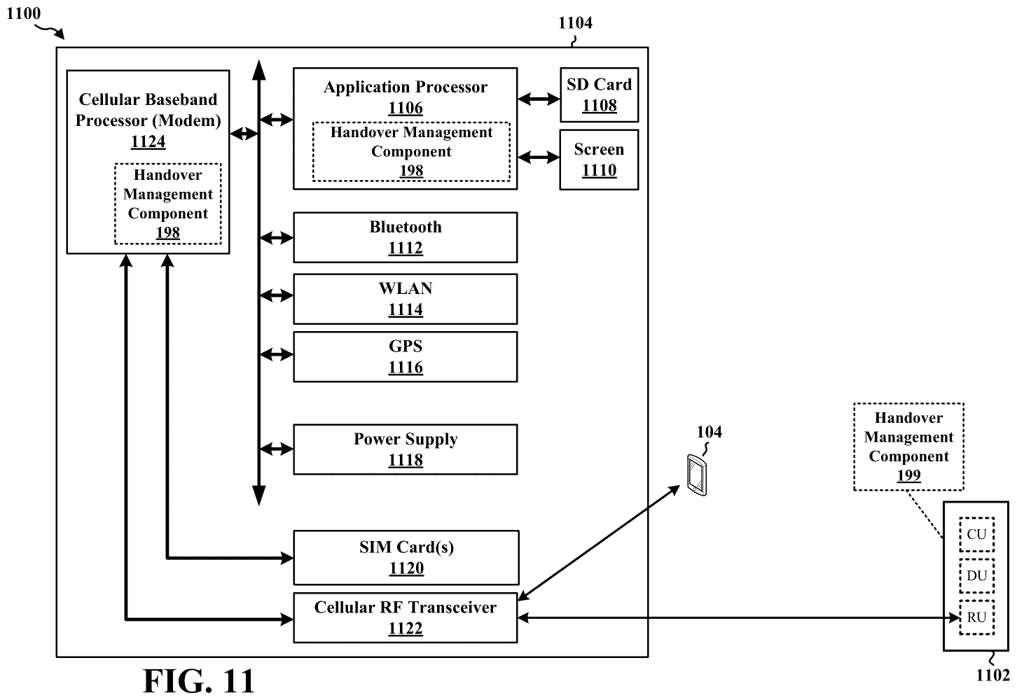

FIG. 11 is a diagram 1100 illustrating an example of a hardware implementation for an apparatus 1104 and a network entity 1102. The apparatus 1104 may be a UE, a component of a UE, or may implement UE functionality. The network entity 1102 may be a BS, a component of a BS, or may implement BS functionality. In some aspects, the apparatus 1104 may include a cellular baseband processor 1124 (also referred to as a modem) coupled to a cellular RF transceiver 1122. In some aspects, the apparatus 1104 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1124 communicates through the cellular RF transceiver 1122 with the UE 104 and/or with an RU associated with the network entity 1102. The RU is either part of the network entity 1102 or is in communication with the network entity 1102. The network entity 1102 may include one or more of the CU, DU, and the RU. The cellular baseband processor 1124 and the application processor 1106 may each include a computer-readable medium/memory. Each computer-readable medium/memory may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198, e.g., the handover management component 198, is configured to perform a handover to a target cell, store target cell information for the target cell in database of target cells to which the UE has performed the handover, and detect a handover condition based on a number of instances of the target cell in the database of the target cells to which the UE has performed the handover. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for performing a handover to a target cell, means for storing target cell information for the target cell in database of target cells to which the UE has performed the handover, means for detecting a handover condition based on a number of instances of the target cell in the database of the target cells to which the UE has performed the handover, and means for detecting the handover condition if a same target cell has a threshold number of instances in the database within a period of time. The apparatus 1104 includes means for receiving a list of cells associated with at least one of the threshold number of instances or the period of time. The apparatus 1104 includes means for excluding the target cell from a handover decision in response to detecting the handover condition, and means for excluding a blind cell handover from detecting the handover condition. The apparatus 1104 includes means for removing an earliest target cell entry in the database in response to the database reaching a threshold amount of entries, and means for removing each entry of the target cell from the database in response to detecting the handover condition. The apparatus 1104 includes means for starting a timer in response to detecting the handover condition, means for applying an offset to a cell measurement while the timer is running, and means for skipping the offset to the cell measurement while the timer is running and the UE is in a high speed mode, is performing VoNR, or is performing NRDC. The apparatus 1104 includes means for receiving a configuration of the offset, and means for adjusting the offset based on a cell power. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the component 199, e.g., the handover management component 199, is configured to determine a list of cells that are candidates for a handover condition, and transmit the list of cells associated with at least one of a threshold number of instances of a target cell or a period of time for detecting a handover condition, wherein the handover condition is detected based on the at least one of the number of instances of the target cell in a database of the target cells to which a UE has performed the handover for the period of time. The component 199 may be within one or more processors (e.g., BBU(s)) of one or more of the CU, DU, and the RU. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for determining a list of cells that are candidates for a handover condition, means for transmitting the list of cells associated with at least one of a threshold number of instances of a target cell or a period of time for detecting a handover condition, and means for transmitting a configuration of an offset, where the offset is applied to a cell measurement to exclude the target cell from a handover decision in response to detecting the handover condition. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

The UE may store target cell information to a database based on performing a handover to the target cell and detecting the ping-pong condition based on a number of handover instances in the database of the target cell to which the UE has performed the handover being greater than or equal to a threshold number of the handover instances within a period of time. The UE may receive, from a base station a list of ping-pong cell candidates and adjust the number of handover instances of the target cell and/or the period of time based on the list of ping-pong cell candidates. The UE may avoid or reduce the handover to the identified ping-pong cell based on the detected ping-pong handover by applying an offset to the measurement of the target cell.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method of wireless communication at a UE, including performing a handover to a target cell, storing target cell information for the target cell in database of target cells to which the UE has performed the handover, and detecting a handover condition based on a number of instances of the target cell in the database of the target cells to which the UE has performed the handover.

Aspect 2 is the method of aspect 1, performing a handover to a target cell, storing target cell information for the target cell in database of target cells to which the UE has performed the handover, and detecting a handover condition based on a number of instances of the target cell in the database of the target cells to which the UE has performed the handover.

Aspect 3 is the method of aspect 2, where at least one of the threshold number of instances or the period of time is different for an intra-frequency handover condition and an inter-frequency handover condition.

Aspect 4 is the method of any of aspects 2 or 3, further including receiving a list of cells associated with at least one of the threshold number of instances or the period of time.

Aspect 5 is the method of any of aspects 1 to 4, further including excluding the target cell from the number of instances on which the handover condition is detected.

Aspect 6 is the method of any of aspects 1 to 5, further including excluding a blind cell handover from the number of instances on which on which the handover condition is detected.

Aspect 7 is the method of any of aspects 1 to 6, where the target cell information is stored in the database based on at least one of the handover being an intra-frequency handover that is not a same cell handover or a blind handover, or the handover being an inter-frequency handover that is not the blind handover.

Aspect 8 is the method of any of aspects 1 to 7, further including removing an earliest target cell entry in the database in response to the database reaching a threshold amount of entries.

Aspect 9 is the method of any of aspects 1 to 8, further including removing each entry of the target cell from the database in response to detecting the handover condition.

Aspect 10 is the method of any of aspects 1 to 9, where the target cell information stored in the database is independent of a CGI.

Aspect 11 is the method of any of aspects 1 to 10, where the database of the target cells to which the UE has performed the handover is maintained while the UE is in an RRC idle state and an RRC connected state.

Aspect 12 is the method of any of aspects 1 to 11, further including starting a timer in response to detecting the handover condition, and applying an offset to a cell measurement while the timer is running.

Aspect 13 is the method of aspect 12, further including skipping the offset to the cell measurement while the timer is running and the UE is in a high speed mode, is performing VoNR, or is performing NRDC.

Aspect 14 is the method of aspect 13, where the cell measurement is an RSRP measurement.

Aspect 15 is the method of any of aspects 12 to 14, where the offset is different for an intra-frequency handover measurement and an inter-frequency handover measurement.

Aspect 16 is the method of any of aspects 12 to 15, further including receiving a configuration of the offset.

Aspect 17 is the method of any of aspects 12 to 16, further including adjusting the offset based on a cell power.

Aspect 18 is the method of any of aspects 1 to 17, where the handover is for a sub 6 GHz PCC cell handover.

Aspect 19 is an apparatus for wireless communication including at least one processor coupled to a memory and configured to implement any of aspects 1 to 18, further including a transceiver coupled to the at least one processor.

Aspect 20 is an apparatus for wireless communication including means for implementing any of aspects 1 to 18.

Aspect 21 is a non-transitory computer-readable medium storing computer executable code, where the code when executed by a processor causes the processor to implement any of aspects 1 to 18.

Aspect 22 is a method of wireless communication at a base station, including determining a list of cells that are candidates for a handover condition, and transmitting the list of cells associated with at least one of a threshold number of instances of a target cell or a period of time for detecting a handover condition, where the handover condition is based on the threshold number of instances of the target cell in a database of target cells to which a UE has performed the handover within the period of time.

Aspect 23 is the method of aspect 22, further including: transmitting a configuration of an offset, where the offset is applied to a cell measurement to exclude the target cell from a handover decision in response to detecting the handover condition.

Aspect 24 is an apparatus for wireless communication including at least one processor coupled to a memory and configured to implement any of aspects 22 and 23, further including a transceiver coupled to the at least one processor.

Aspect 25 is an apparatus for wireless communication including means for implementing any of aspects 22 and 23.

Aspect 26 is a non-transitory computer-readable medium storing computer executable code, where the code when executed by a processor causes the processor to implement any of aspects 22 and 23.

What is claimed is:

1. An apparatus for of wireless communication at a user equipment (UE), comprising:
a memory; and
at least one processor coupled to the memory and, based at least in part on information stored in the memory, the at least one processor is configured to:
perform a handover to a target cell;
store target cell information for the target cell in database of target cells to which the UE has performed the handover; and
detect a handover condition based on a number of instances of the target cell in the database of the target cells to which the UE has performed the handover.

2. The apparatus of claim 1, wherein, to detect the handover condition, the at least one processor is configured to:
detect the handover condition if a same target cell has a threshold number of instances in the database within a period of time.

3. The apparatus of claim 2, wherein at least one of the threshold number of instances or the period of time is different for an intra-frequency handover condition and an inter-frequency handover condition.

4. The apparatus of claim 2, wherein the at least one processor is further configured to:
receive a list of cells associated with at least one of the threshold number of instances or the period of time.

5. The apparatus of claim 1, wherein the at least one processor is further configured to:
exclude an intra-frequency same cell handover from the number of instances on which the handover condition is detected.

6. The apparatus of claim 1, wherein the at least one processor is further configured to:
exclude a blind cell handover from the number of instances on which the handover condition is detected.

7. The apparatus of claim 1, wherein the target cell information is stored in the database based on at least one of:
the handover being an intra-frequency handover that is not a same cell handover or a blind handover, or
the handover being an inter-frequency handover that is not the blind handover.

8. The apparatus of claim 1, wherein the at least one processor is further configured to:
remove an earliest target cell entry in the database in response to the database reaching a threshold amount of entries.

9. The apparatus of claim 1, wherein the at least one processor is further configured to:
remove each entry of the target cell from the database in response to detecting the handover condition.

10. The apparatus of claim 1 wherein the target cell information stored in the database is independent of a cell global identity (CGI).

11. The apparatus of claim 1, wherein the database of the target cells to which the UE has performed the handover is maintained while the UE is in a radio resource control (RRC) idle state and an RRC connected state.

12. The apparatus of claim 1, wherein the at least one processor is further configured to:
start a timer in response to detecting the handover condition; and
apply an offset to a cell measurement while the timer is running.

13. The apparatus of claim 12, wherein the at least one processor is further configured to:
skip the offset to the cell measurement while the timer is running and the UE is in a high speed mode, is performing voice over new radio (VoNR), or is performing new radio dual connectivity (NRDC).

14. The apparatus of claim 13, wherein the cell measurement is a reference signal received power (RSRP) measurement.

15. The apparatus of claim 12, wherein the offset is different for an intra-frequency handover measurement and an inter-frequency handover measurement.

16. The apparatus of claim 12, wherein the at least one processor is further configured to:
receive a configuration of the offset.

17. The apparatus of claim 12, wherein the at least one processor is further configured to:
adjust the offset based on a cell power.

18. The apparatus of claim 1, further comprising a transceiver coupled to the at least one processor,
wherein the handover is for a sub 6 GHz primary component carrier (PCC) cell handover.

19. An apparatus for of wireless communication at a network node, comprising:
a memory; and
at least one processor coupled to the memory and, based at least in part on information stored in the memory, the at least one processor is configured to:
determine a list of cells that are candidates for a handover condition; and
transmit the list of cells associated with at least one of a threshold number of instances of a target cell or a period of time for detecting the handover condition,
wherein the handover condition is based on the threshold number of instances of the target cell in a database of target cells to which a user equipment (UE) has performed the handover within the period of time.

20. The apparatus of claim 19, wherein the at least one processor is further configured to:
transmit a configuration of an offset, wherein the offset is applied to a cell measurement to exclude the target cell from a handover decision in response to detecting the handover condition.

21. A method of wireless communication at user equipment (UE), comprising:
performing a handover to a target cell;
storing target cell information for the target cell in database of target cells to which the UE has performed the handover; and
detecting a handover condition based on a number of instances of the target cell in the database of the target cells to which the UE has performed the handover.

22. The method of claim 21, wherein detecting the handover condition further comprises:
detecting the handover condition if a same target cell has a threshold number of instances in the database within a period of time.

23. The method of claim 22, further comprising:
receiving a list of cells associated with at least one of the threshold number of instances or the period of time.

24. The method of claim 21, further comprising:
excluding an intra-frequency same cell handover or a blind cell handover from the number of instances on which the handover condition is detected.

25. The method of claim 21, further comprising:
removing each entry of the target cell from the database in response to detecting the handover condition.

26. The method of claim 21, further comprising:
starting a timer in response to detecting the handover condition; and
applying an offset to a cell measurement while the timer is running.

27. The method of claim 26, further comprising:
skipping the offset to the cell measurement while the timer is running and the UE is in a high speed mode, is performing voice over new radio (VoNR), or is performing new radio dual connectivity (NRDC).

28. The method of claim 26, further comprising:
receiving a configuration of the offset.

29. The method of claim 26, further comprising:
adjusting the offset based on a cell power.

30. A method of wireless communication at a network node, comprising:
determining a list of cells that are candidates for a handover condition; and
transmitting the list of cells associated with at least one of a threshold number of instances of a target cell or a period of time for detecting the handover condition,
wherein the handover condition is based on the threshold number of instances of the target cell in a database of target cells to which a user equipment (UE) has performed the handover within the period of time.
